(19) United States
(12) Patent Application Publication
(10) Pub. No.: US 2010/0247024 A1
(43) Pub. Date: Sep. 30, 2010

(54) OPTICAL WAVEGUIDE TYPE DEVICE

(75) Inventors: Yuhki Kinpara, Tokyo (JP); Toru Sugamata, Tokyo (JP)

Correspondence Address: CHAPMAN AND CUTLER, 111 WEST MONROE STREET, CHICAGO, IL, 60603, US

(73) Assignee: Sumitomo Osaka Cement Co., Ltd., Chiyoda-ku (JP)

(21) Appl. No.: 12/733,873

(22) PCT Filed: Sep. 25, 2008
(86) PCT No.: PCT/JP2008/067246

§ 371 Date: Mar. 25, 2010

(30) Foreign Application Priority Data
Sep. 28, 2007 (JP) 2007-256579

(51) Int. Cl. G02F 1/035; G02B 6/12

(52) U.S. Cl. 385/2; 385/14

(57) ABSTRACT

An optical waveguide type device employing an X-cut substrate having an electro-optical effect is provided in which the modulation efficiency due to an electric field formed by control electrodes is improved. The optical waveguide type device includes: an X-cut substrate having an electro-optical effect; an optical waveguide formed on the substrate; and a control electrode controlling an optical wave propagating in the optical waveguide and including a signal electrode and a ground electrode. Here, the bottom surface of at least one of the signal electrode and the ground electrode disposed to interpose the optical waveguide therebetween is lower (by a height difference d) than the top surface on which the optical waveguide is formed.

### TECHNICAL FIELD

The present invention relates to an optical waveguide type device, and more particularly, to an optical waveguide type device having an optical waveguide and control electrodes, which interpose the optical waveguide therebetween, on an X-cut substrate.

### BACKGROUND ART

Recently, in the fields of optical communications and optical measurements, an optical waveguide type device in which an optical waveguide and control electrodes are formed on an X-cut substrate having an electro-optical effect has been used. In the X-cut substrate, since a direction in which the electro-optical effect is most efficiently exhibited with the electric field applied to the substrate is a direction parallel to a substrate surface (a direction parallel to the substrate surface on which the optical waveguide is formed), a signal electrode and a ground electrode constituting the control electrodes are disposed to interpose the optical waveguide therebetween.

On the other hand, to increase the bandwidth of the optical waveguide type device, as described in Patent Citation 1 or 2, the thickness of the substrate is set to 20 μm or less and the speeds of a micro wave which is an electrical signal and an optical wave propagating in the optical waveguide are matched.

### Citation List

Patent Citation 1: Japanese Patent Application Laid-Open No. 64-18121

Patent Citation 2: Japanese Patent Application Laid-Open No. 2003-215519

When the substrate is a thin substrate with a thickness of 20 μm or 15 μm or less, the mechanical strength of the substrate is small. Accordingly, as shown in FIG. 1, a reinforcing substrate 6 is generally bonded to the back surface of the substrate 1 with an adhesive layer 5 interposed therebetween and formed of a low-dielectric layer. Reference numeral 2 represents an optical waveguide, reference numeral 3 represents a signal electrode, and reference numeral 4 represents a ground electrode.

The thin substrate 1 is markedly affected by a variation in refractive index due to a variation in material (for example, between the air layer and the substrate and between the substrate and the adhesive layer) in the thickness direction of the substrate. Accordingly, in the past, in the substrate 1 with a typical thickness, as shown in FIG. 2A, the optical wave propagating in the optical waveguide is concentrated on the front surface of the substrate 1. On the contrary, in the thin plate, as shown in FIG. 2B, the optical wave is likely to be confined in the vicinity of the center of the substrate. Particularly, when the optical waveguide is formed by using a substrate formed of lithium niobate and diffusing Ti, this phenomenon is marked.

When the thin X-cut substrate is used, as shown in FIG. 3, an optical peak position 22 of the optical wave propagating in the optical waveguide 2 is located in the vicinity of the center of the substrate 1. However, regarding the electric field formed by the signal electrode 3 and the ground electrode 4, the electric field 30 close to the substrate surface is stronger than the electric field 31 passing through the vicinity of the center of the optical peak position 22 and thus the location with the stronger electric field does not overlap with the optical peak position, whereby the optical control is not efficient.

### DISCLOSURE OF INVENTION

### Technical Problem

An advantage of some aspects of the invention is that it provides an optical waveguide type device employing an X-cut substrate in which the modulation efficiency due to the electric field formed by the control electrodes is improved and a low driving voltage can be used.

### Technical Solution

According to an aspect of the invention, there is provided an optical waveguide type device including: an X-cut substrate having an electro-optical effect; an optical waveguide formed on the substrate; and a control electrode controlling an optical wave propagating in the optical waveguide and including a signal electrode and a ground electrode, wherein the bottom surface of at least one of the signal electrode and the ground electrode disposed to interpose the optical waveguide therebetween is lower than the top surface on which the optical waveguide is formed.

In the optical waveguide type device, when the thickness of the substrate is equal to or less than 15 μm, the larger height difference (hereinafter, referred to as height difference d) between the bottom surfaces of the signal electrode and the ground electrode and the top surface of the substrate on which the optical waveguide is formed may be equal to or smaller than about ⅓ of the thickness of the substrate.

In the optical waveguide type device, when the thickness of the substrate is greater than 15 μm, the larger height difference d between the bottom surfaces of the signal electrode and the ground electrode and the top surface of the substrate on which the optical waveguide is formed may be equal to or smaller than about 5 μm.

In the optical waveguide type device, a low-dielectric layer may be disposed on the back surface of the substrate.

### ADVANTAGEOUS EFFECTS

According to the above-mentioned configuration, in the optical waveguide type device including the X-cut substrate having an electro-optical effect, the optical waveguide formed on the substrate, and the control electrode controlling an optical wave propagating in the optical waveguide and including a signal electrode and a ground electrode, the bottom surface of at least one of the signal electrode and the ground electrode disposed to interpose the optical waveguide therebetween is lower than the top surface of the substrate on which the optical waveguide is formed. Accordingly, the location with a strong electric field formed by the signal electrode and the ground electrode comes close to the center of the substrate and the overlapping of the optical peak position of the optical wave propagating in the optical waveguide and the location with the strong electric field increases, thereby improving the modulation efficiency. The modulation efficiency means (driving voltage at height difference d>0)/(driving voltage at height difference d=0).

According to the above-mentioned configuration, when the thickness of the substrate is equal to or less than 15 μm, the height difference d is equal to or smaller than about ⅓ of the thickness of the substrate. Accordingly, the overlapping of the optical peak position of the optical wave and the location with the strong electric field is greater than ones in the past without the height difference, thereby improving the modulation efficiency.

According to the above-mentioned configuration, when the thickness of the substrate is greater than 15 μm, the height difference d is equal to or smaller than about 5 μm. Accordingly, the overlapping of the optical peak position of the optical wave and the location with the strong electric field is greater than ones in the past without the height difference, thereby improving the modulation efficiency.

According to the above-mentioned configuration, a low-dielectric layer is disposed on the back surface of the substrate. Accordingly, similarly, since the optical peak position of the optical wave propagating in the optical waveguide comes closer to the vicinity of the center of the substrate, the invention can be more suitably utilized.

### BRIEF DESCRIPTION OF DRAWINGS

FIG. 1 is a sectional view illustrating an optical waveguide type device employing a thin substrate.

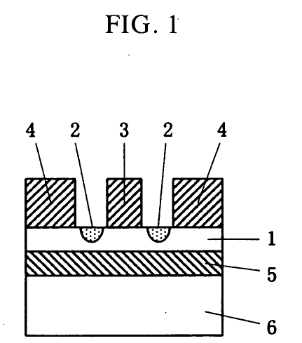

FIGS. 2A and 2B are diagrams schematically illustrating an optical wave distribution in a conventional substrate and a thin substrate, respectively.

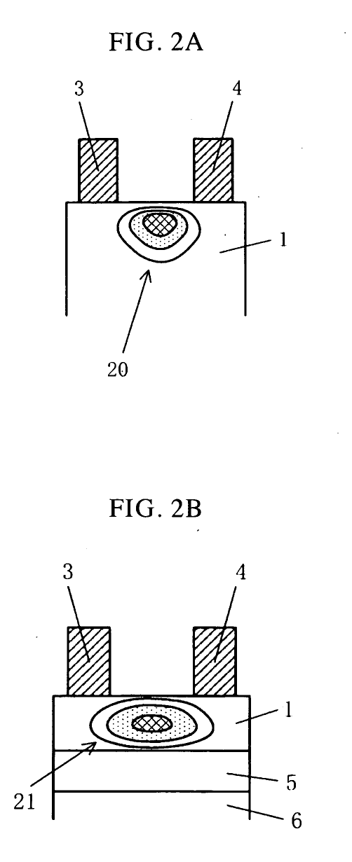

FIG. 3 is a diagram schematically illustrating the relation between an optical beam position and a location with a strong electric field in the optical waveguide type device employing the thin substrate.

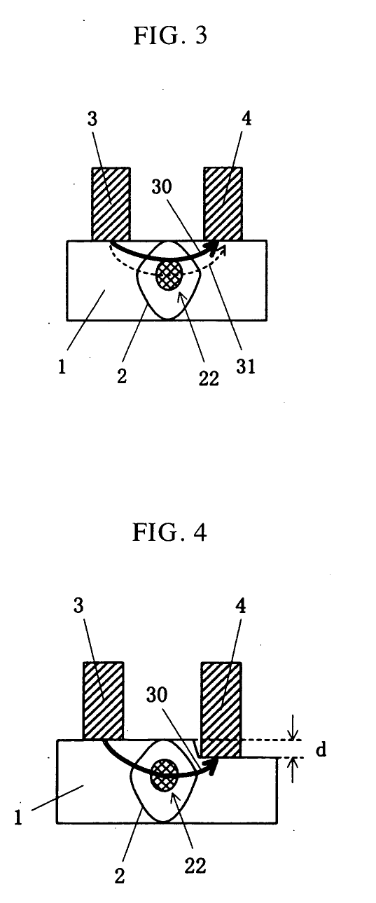

FIG. 4 is a sectional view illustrating an optical waveguide type device according to an embodiment of the invention.

FIG. 5 is a sectional view illustrating an optical waveguide type device according to another embodiment of the invention.

FIGS. 6A to 6C are sectional views illustrating the shapes of a branched waveguide where the invention is applied to an optical waveguide type device having a Mach-Zehnder type optical waveguide.

FIG. 7 is a graph illustrating a variation characteristic in modulation efficiency with respect to a height difference d between the bottom surface of the signal electrode and the top surface on which the optical waveguide is formed.

FIG. 8 is a sectional view illustrating an optical waveguide type device according to another embodiment of the invention.

### EXPLANATION OF REFERENCES

1: SUBSTRATE
2, 23, 24: OPTICAL WAVEGUIDE
3: SIGNAL ELECTRODE
4, 40, 41: GROUND ELECTRODE
5: ADHESIVE LAYER
6: REINFORCING SUBSTRATE
20, 21: OPTICAL WAVE DISTRIBUTION
22: OPTICAL BEAM POSITION

### BEST MODE FOR CARRYING OUT THE INVENTION

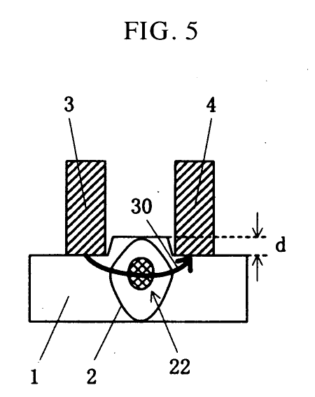

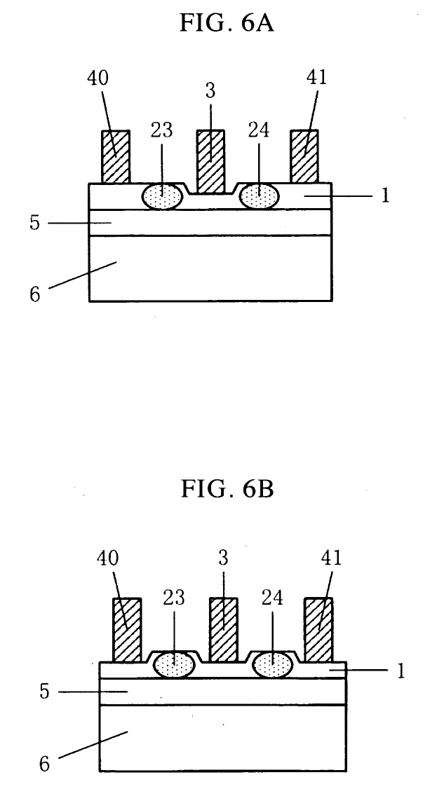

Hereinafter, an optical waveguide type device according to exemplary embodiments of the invention will be described in detail. FIGS. 4, 5, and 8 are diagrams illustrating principal features of the optical waveguide type device according to the exemplary embodiments of the invention. The optical waveguide type device according to the embodiments of the invention shown in FIG. 4 or 5 includes an X-cut substrate 1 having an electro-optical effect and having a thickness equal to or less than 15 μm, an optical waveguide 2 formed on the substrate, and control electrodes controlling an optical wave propagating in the optical waveguide and including a signal electrode 3 and a ground electrode 4. Here, the height differences d between the bottom surfaces of the signal electrode and the ground electrode disposed to interpose the optical waveguide therebetween and the top surface of the substrate on which the optical waveguide is formed are equal to or smaller than about ⅓ of the thickness of the substrate.

In FIG. 4, the bottom surface of one electrode (which is the ground electrode 4 in FIG. 4, but may be the signal electrode 3) of the control electrodes interposing the optical waveguide 2 therebetween is located lower than the top surface of the substrate on which the optical waveguide is formed. Accordingly, the location with a strong electric field 30 formed by the signal electrode and the ground electrode approaches the center of the substrate and the overlapping of the optical peak position 22 of the optical wave propagating in the optical waveguide and the location with the strong electric field increases, thereby improving the modulation efficiency.

In FIG. 5, the bottom surfaces of both control electrodes (the signal electrode 3 and the ground electrode 4) interposing the optical waveguide 2 therebetween are located lower than the top surface on which the optical waveguide is formed. Accordingly, the location with a strong electric field 30 formed by the signal electrode and the ground electrode comes closer to the center of the substrate than the one in FIG. 4 and the overlapping of the optical peak position 22 of the optical wave propagating in the optical waveguide and the location with the strong electric field further increases, thereby improving the modulation efficiency.

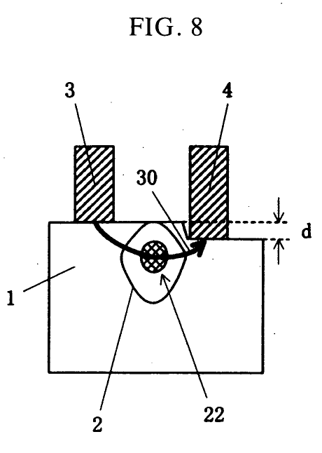

The optical waveguide type device according to the embodiment of the invention shown in FIG. 8 includes an X-cut substrate 1 having an electro-optical effect and having a thickness greater than 15 μm, an optical waveguide 2 formed on the substrate, and control electrodes controlling an optical wave propagating in the optical waveguide and including a signal electrode 3 and a ground electrode 4. Here, the bottom surface of one electrode (which is the ground electrode 4 in FIG. 8, but may be the signal electrode 3) of the control electrodes interposing the optical waveguide 2 therebetween is located lower than the top surface of the substrate on which the optical waveguide is formed. Accordingly, the location with the strong electric field 30 formed by the signal electrode and the ground electrode moves to the inside of the substrate and the overlapping of the optical peak position 22 of the optical wave propagating in the optical waveguide and the location with the strong electric field increases, thereby further improving the modulation efficiency.

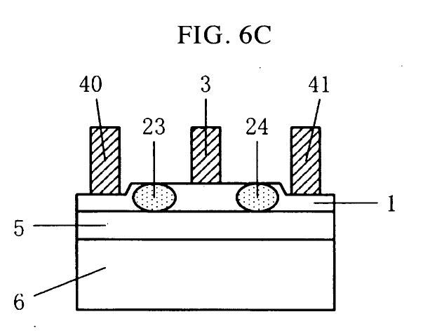

In FIGS. 6A to 6C, the arrangement relations between the optical waveguide 2 and the control electrodes 3 and 4, which are the features of the invention shown in FIG. 4 or 5, are applied to the optical waveguide type device having two branched waveguides 23 and 24, like a Mach-Zehnder type optical waveguide.

The substrate 1 has an electro-optical effect and can be formed of, for example, lithium niobate, lithium tantalite, PLZT (Lead Lanthanum Zirconate Titanate), silica material, or combinations thereof. Particularly, crystals of lithium niobate (LN) or lithium tantalite (LT) having a high electro-optical effect can be suitably employed. Regarding the crystallization direction of the substrate, the X-cut substrate having a direction parallel to a substrate surface (a direction parallel to the substrate surface on which the optical waveguide is formed) as a direction in which the electro-optical effect is most efficiently exhibited with the electric field applied to the substrate is used.

A dry etching method, a chemical etching method, or a laser processing method is used to form various uneven portions shown in FIG. 6 in the substrate on which the signal electrode or the ground substrate is formed, and the uneven portions may be formed before or after decreasing the thickness of the substrate 1.

One surface of the substrate is polished to decrease the thickness of the substrate 1. When the uneven portions are formed in advance in the top surface of the substrate, the back surface of the substrate is polished. In polishing the substrate, thermo-plastic resin is applied to the surface of the substrate, a polishing jig is attached thereto, and the back surface of the substrate is polished using a lapping and polishing machine.

A reinforcing substrate 6 is bonded to the substrate 1 of which the thickness is decreased with an adhesive layer 5 interposed therebetween. Various materials can be used for the reinforcing substrate 6, materials such as quartz, glass, and alumina having a lower dielectric constant than the thin plate or materials having a crystal orientation different from the thin substrate may be used in addition to the same material as the thin substrate. However, it is preferable that a material having a linear expansion coefficient equivalent to that of the thin substrate be selected, which is advantageous for stabilizing the operating characteristics of the optical waveguide type device with respect to a variation in temperature.

Various adhesive materials such as epoxy adhesives, heat-curable adhesives, UV-curable adhesives, solder glass, and heat-curable, light-curable, or heat-thickening resin adhesive sheets can be used as the adhesive layer 5. Particularly, when a low-dielectric material is used as the adhesive layer, it is possible to increase the bandwidth of the optical waveguide type device and it is easy to shift the optical beam position to the vicinity of the center of the substrate, which is advantageous in application of the configuration according to the embodiments of the invention.

The optical waveguide is formed before decreasing the thickness of the substrate or before or after bonding the reinforcing substrate 6 to the thin substrate. The optical waveguides 23 and 24 can be formed by diffusing Ti or the like onto the surface of the substrate using a thermal diffusion method or a proton-exchange method. The control electrodes such as the signal electrode 3 and the ground electrodes 40 and 41 can be formed by forming electrode patterns of Ti or Au or by using a gold plating method.

In FIG. 6A, a concave portion is formed at a position of the substrate 1 on which the signal electrode 3 is formed, and the bottom surface of the signal electrode 3 is located lower than the top surface on which the optical waveguides 23 and 24 are formed. In FIG. 6B, concave portions are formed at positions where the signal electrode 3 and the ground electrodes 40 and 41 are formed, and both bottom surfaces of the signal electrode 3 and the ground electrodes 40 and 41 are located lower than the top surface on which the optical waveguides 23 and 24 are formed. In FIG. 6C, concave portions are formed at positions where the ground electrodes 40 and 41 are formed, and the bottom surfaces of the ground electrodes 40 and 41 are located lower than the top surface on which the optical waveguides 23 and 24 are formed.

When the shapes of the optical waveguide type devices shown in FIGS. 6A to 6C are different from each other, the position with the strong electric field is changed, and with the shape shown in FIG. 6B, the strong electric field can be generated at the deepest position in the substrate.

The variation in modulation efficiency in the optical waveguide type device having the shape shown in FIG. 6A was simulated when the height difference d between the bottom surface of the signal electrode and the top surface on which the optical waveguide is formed is changed.

The simulation conditions were set as follows:

material of substrate: lithium niobate;

height of ground electrodes 40 and 41: 22 μm;

width of ground electrodes 40 and 41: 200 μm;

height of signal electrode: (height of ground electrode+height difference d) μm;

width of signal electrode: 10 μm;

distance between signal electrode and ground electrode: 20 μm;

width of optical waveguide (23, 24): 7 μm;

thickness of substrate: 15 μm;

adhesive layer 5: adhesive having refractive index lower than that of lithium niobate; and

reinforcing substrate 6: lithium niobate.

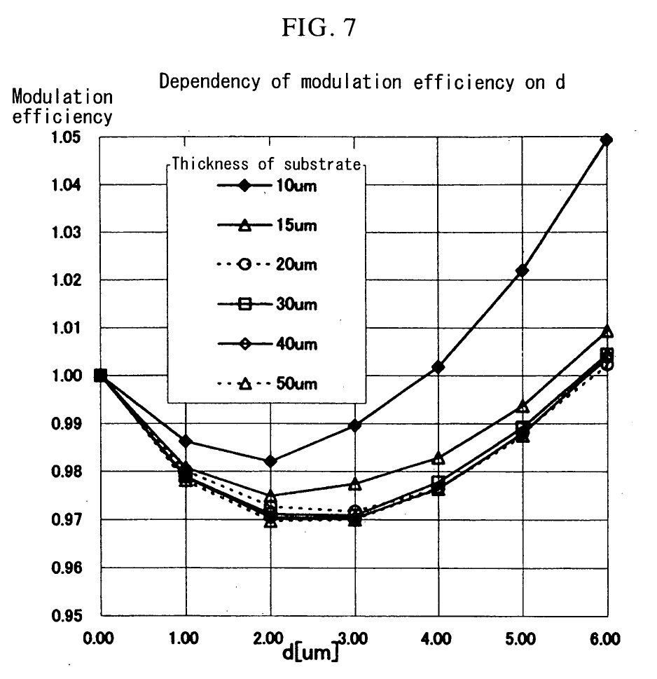

The simulation result of the height difference d vs. modulation efficiency characteristic when the thickness of the substrate is changed to 10 μm, 20 μm, 30 μm, and 40 μm is shown in FIG. 7.

It can be seen from the graph shown in FIG. 7 that the modulation efficiency is improved when the thickness of the substrate is equal to or less than 15 μm and the height difference d is equal to or smaller than about ⅓ of the thickness of the substrate. It is proved from the simulation result that the modulation efficiency is improved by setting the height difference d to 5 μm or less regardless of the thickness of the substrate when the thickness of the substrate is greater than 15 μm.

### INDUSTRIAL APPLICABILITY

According to the above-mentioned invention, it is possible to provide an optical waveguide type device employing an X-cut substrate, in which the modulation efficiency due to the electric field formed by the control electrode is improved.

1. An optical waveguide type device comprising:
an X-cut substrate having an electro-optical effect;
an optical waveguide formed on the substrate; and
a control electrode controlling an optical wave propagating in the optical waveguide and including a signal electrode and a ground electrode,
wherein the bottom surface of at least one of the signal electrode and the ground electrode disposed to interpose the optical waveguide therebetween is lower than the top surface on which the optical waveguide is formed.

2. The optical waveguide type device according to claim 1, wherein when the thickness of the substrate is equal to or less than 15 μm, the larger height difference between the bottom surfaces of the signal electrode and the ground electrode and the top surface of the substrate on which the optical waveguide is formed is equal to or smaller than about ⅓ of the thickness of the substrate.

3. The optical waveguide type device according to claim 1, wherein when the thickness of the substrate is greater than 15 μm, the larger height difference between the bottom surfaces of the signal electrode and the ground electrode and the top surface of the substrate on which the optical waveguide is formed is equal to or smaller than about 5 μm.

4. The optical waveguide type device according to claim 1, wherein a low-dielectric layer is disposed on the back surface of the substrate.

5. The optical waveguide type device according to claim 2, wherein a low-dielectric layer is disposed on the back surface of the substrate.

6. The optical waveguide type device according to claim 3, wherein a low-dielectric layer is disposed on the back surface of the substrate.
